(19) United States
(12) Patent Application Publication
(10) Pub. No.: US 2018/0143081 A1
(43) Pub. Date: May 24, 2018

(54) IDENTIFYING A TEMPERATURE ANOMALY

(71) Applicant: Philips Lighting Holding B.V., Eindhoven (NL)

(72) Inventor: Tony Petrus VAN ENDERT, Lommel (BE)

(21) Appl. No.: 15/568,013

(22) PCT Filed: Apr. 12, 2016
(86) PCT No.: PCT/EP2016/058027

§ 371 Date: Oct. 20, 2017

(30) Foreign Application Priority Data
Apr. 21, 2015 (EP) 15164472.1

(51) Int. Cl. G01K 1/02; F24F 11/33; G05D 23/19; G05B 15/02

(52) U.S. Cl. CPC G01K 1/026; G05B 15/02; G05D 23/1932; F24F 11/33

(57) ABSTRACT

A device comprising: a communications interface configured to receive one or more first signals each indicating a respective temperature level sensed by a respective first temperature sensor located above a surface, and to receive one or more second signals each indicating a respective temperature level sensed by a respective second temperature sensor located below said surface; and detection logic configured to compare the one or more first 5 signals with the one or more second signals to identify a temperature anomaly above or below said surface, and thereby generate an output indicative of said temperature anomaly.

### TECHNICAL FIELD

The present disclosure relates to the identification of temperature anomalies in an environment such as a building, e.g. to detect and potentially mitigate potential hazards.

### BACKGROUND

Traditional alarm systems consist of individual detecting units placed below the ceiling. These units are designed to detect the presence of hazards such as fires through the detection of heat and/or smoke. This way, a user can be alerted to potential hazards and take appropriate action.

There is an increasing trend towards utilities being networked together. For example, in a networked lighting system, there are often a multitude of temperature sensors present as part of the system. Some are general purpose temperature sensors (e.g. passive infrared sensors, temperature sensors for climate systems), whereas others are dedicated to specific tasks (e.g. a temperature sensor in a driver of a light source, or sensors integrated in an IC embedded in a device mounted in or above the ceiling).

### SUMMARY

In an environment such as an office with a suspended ceiling, potential hazards below the ceiling are usually easy to detect and localize because they may be in plain view or detected by a traditional alarm system (e.g. a smoke alarm). For example, smoke coming from an electrical device, a leaking water tank, etc. may be noticeable or at least easy to detect. This is not the case when devices are involved that are located above the ceiling (or otherwise out of view). In a Power over Ethernet based lighting system for example, a Power Sourcing Equipment (PSE) failing and dissipating tremendous heat could go unnoticed. As a practical example, the packaging material of a PSE may cause the PSE to heat up beyond acceptable operating temperatures. Similarly, broken electrical wiring may dissipate heat along the cable where there is a crack in the wiring. Or if an HVAC system is leaking cold air or a water pipe is leaking hot water (e.g. which then evaporates), then this can also go unnoticed for some time. It would be desirable to notice such potential fault conditions more readily, e.g. to allow the cause to be fixed or to prevent damage.

It is an object of the present invention to address one or more of the above-mentioned issues, or similar.

Hence, according to one aspect disclosed herein, there is provided a device comprising a communications interface configured to receive one or more first signals each indicating a respective temperature level sensed by a respective first temperature sensor located above a surface, and to receive one or more second signals each indicating a respective temperature level sensed by a respective second temperature sensor located below said surface; and detection logic configured to compare the one or more first signals with the one or more second signals to identify a temperature anomaly above or below said surface, and thereby generate an output indicative of said temperature anomaly.

It is recognised herein that there will be a relationship between temperature measurements taken below a surface such as a ceiling (e.g. by a passive infrared sensor) and temperature measurements taken above the surface (e.g. by a driver in a luminaire and/or PSE), such that heat generated by a source below the ceiling would also be detectable (to a lesser extent) above the ceiling due to the fact that heat rises. Departures from this expected relationship may be identified as “temperature anomalies”. E.g. these may be identified based on the known location of devices above and below ceiling, after commissioning.

In embodiments, the detection logic is configured to generate a first heat map based on the one or more first signals, and to generate a second heat map based on the one or more second signals; and said comparison comprises a comparison between the first and second heat maps.

In embodiments, the detection logic may be further configured to identify a location of the temperature anomaly based on said comparison, and the output may be indicative of the location of the temperature anomaly. Advantageously, this allows a user to be informed of information indicating the approximate location of the anomaly. For example, this would allow the user to address the issue quicker.

In embodiments, the detection logic may be further configured to determine a cause of the temperature anomaly based on said comparison, and the output may be further indicative of said cause of the temperature anomaly. E.g. the diagnosis may be performed by controlling one or more temperature control devices that are potential sources of the anomaly (e.g. heaters, boilers, air-con units) and observing an effect on said comparison, and/or by comparing the heat map to one or more predetermined locations of one or more potential sources of the anomaly (e.g. again one or more temperature control devices such as heaters, boilers, air-con units, etc.). Advantageously, this allows embodiments of the present invention to indicate the cause to a user such that they may prepare accordingly, for example by bringing a fire extinguisher to a fire, or by turning off, isolating or removing the faulty device.

In embodiments, the the detection logic is further configured to control one or more temperature control devices based on the cause of the temperature anomaly to mitigate said cause of the temperature anomaly. For example, this may comprise automatically turning off one or more temperature control devices causing the anomaly (e.g. a device emitting heat). As another example, the detection logic could control a temperature control device (e.g. a HVAC system) to heat up or cool down the affected area to counteract the anomaly.

In embodiments, the device further comprises a memory storing at least one predetermined criterion defining the temperature anomaly in terms of at least one respective difference to be detected based on the comparison of the one or more first signals with the one or more second signals. For example this could be a threshold temperature difference whereby an anomaly is to be declared if the difference between the temperature sensed above and below the ceiling goes beyond this at any location, or a threshold area or width beyond which a temperature anomaly is to be identified if greater than the threshold temperature difference is detected consistently across that area or width (or perhaps at greater than a predetermined number of points within that area or width). In such cases the detection logic is further configured to perform said comparison by comparing the temperature anomaly to perform said comparison by reference to the at least one criterion stored in the memory. Advantageously, this allows minor temperature anomalies to be classified as causing no concern, or a lower level of concern.

In various embodiments of the present invention, the temperature anomaly is one of a hot spot or a cold spot.

In embodiments, the first and second temperature sensors may each be one of a passive infrared sensor, a driver in a luminaire, a power sourcing equipment, a climate system, a thermopile, a pyrometer, a thermistor, a thermocouple, a thermopile, and a bi-metallic strip.

According to another aspect of the present invention, there is disclosed a system for detecting potential hazards in a network of temperature sensors comprising: a device comprising a communications interface and detection logic; a first temperature sensor located above a surface; a second temperature sensor located below said surface; wherein: the communications interface is configured to receive one or more first signals indicating a temperature level sensed by the first temperature sensor, and to receive one or more second signals indicating a temperature level sensed by the second temperature sensor; and the detection logic is configured to compare the one or more first signals and the one or more second signals to identify a temperature anomaly above or below said surface, and thereby generate an output indicative of said temperature anomaly.

In embodiments, the surface may be a horizontal surface.

In embodiments, the surface may be a ceiling.

In embodiments, the one or more first signals are a plurality of first signals each indicating a respective temperature level sensed by a respective one of a plurality of first heat sensors and the one or more second signals are a plurality of second signals each indicating a respective temperature level sensed by a respective one of a plurality of second heat sensors.

In further embodiments, the device of said system may be further configured in accordance with any of the device features disclosed herein.

According to another aspect of the present invention, there is disclosed a method comprising steps of: receiving one or more first signals indicating a temperature level sensed by a first heat sensor located above a surface, receiving one or more second signals indicating a temperature level sensed by a second heat sensor located below said surface, comparing the one or more first signals and the one or more second signals, and generating an output indicative of the comparison between the one or more first signals and the one or more second signals.

In embodiments, the method may further comprise operations in accordance with any of the device or system features disclosed herein.

According to another aspect of the present invention, there is disclosed a computer program product contained on a computer-readable medium which when run one or more processors carries out operations according to any method disclosed herein.

### BRIEF DESCRIPTION OF THE DRAWINGS

To assist understanding of the present disclosure and to show how embodiments may be put into effect, reference is made by way of example to the accompanying drawings in which:

FIG. 1 is a schematic illustrating an arrangement of temperature sensors either side of a surface,

FIG. 2 is a block diagram of an example user device according to embodiments of the present invention,

FIG. 3 shows a method of categorising heat spots as may be employed by the present invention,

FIG. 4 illustrates a typically environment in which the present invention may be employed, and

FIG. 5 shows an example of two heat maps.

### DETAILED DESCRIPTION OF EMBODIMENTS

In embodiments disclosed in the following, temperature measurements taken below the ceiling (e.g. by a passive infrared sensor) and temperature measurements taken above the ceiling (e.g. by a driver in a luminaire and/or PSE) can be used to generate two heat maps, characterising the situation above the ceiling and below the ceiling respectively. There will be a relationship between these heat maps (as heat rises) such that heat generated by a source below the ceiling will also be detectable (to a lesser extent) above the ceiling. Hence, embodiments of the present invention can identify temperature anomalies which may be potential hazards by comparing the heat maps. For example, when a hot spot is detected above the ceiling that does not relate to a heat source detected below the ceiling nor to a known heat source above the ceiling, this may be identified as a potential issue. In general, a temperature anomaly may be detected at a point, or over any contiguous or non-contiguous shape.

The example of a ceiling is used herein by way if illustration, but it is understood that the invention may be implemented relative to any surface which allows heat sensors to be placed above and below that surface. This surface may or may not be horizontal. For example, heat sensors placed above and below a sloped ceiling will still show some relationship between their heat maps (or other measurements) in the manner described above. Where the surface is horizontal, this means horizontal relative to the earth's surface (as that is what defines the pressure gradient that causes heat to rise).

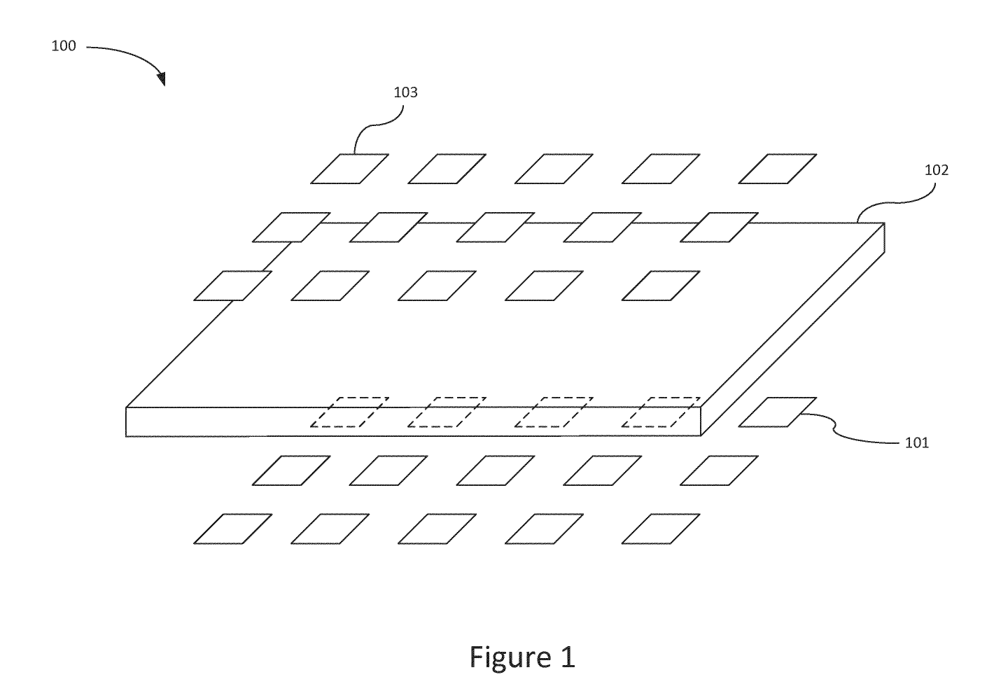

FIG. 1 shows a schematic illustration of a networked temperature sensor system according to embodiments of the present invention. One or more temperature sensors

101 are placed below the ceiling 102 (herein referred to as “lower sensors”), and one or more temperature sensors 103 are placed above the ceiling 102 (herein referred to as “upper sensors”). Each sensor is arranged to detect nearby heat and thereby generate an output indicative of the temperature in the vicinity of that sensor. As the ceiling 102 provides some level of insulation, the lower sensors will either not detect, or detect to a lesser extent, temperature variations above the ceiling, and vice-versa. The array of upper sensors is shown in FIG. 1 to mirror the array of lower sensors (i.e. the horizontal position of each upper sensor 103 is the same as a respective lower sensor 101), but this is not necessarily the case in all possible embodiments.

Each of the upper and lower sensors 103, 101 may take any suitable form, such as a passive infrared sensor, a driver in a luminaire, a sensor of a power sourcing equipment, a climate system, a thermopile, a pyrometer, a thermistor, a thermocouple, a thermopile, or a bi-metallic strip, etc.; and the different sensors above and below the ceiling

102 and/or on the same side of the ceiling 102 do not necessarily have to be the same type. In embodiments, one, some or all of the temperature sensors 101, 103 may be pre-existing sensors that are already present for another purpose, for instance as part of another utility such as a lighting system (e.g. the sensors may comprise one or more temperature sensors each in a respective driver of a respective light source that exists to detect faults in the driver, and/or one or more infrared sensors used for presence detection to control the lighting). Alternatively or additionally, one, some or all of the temperature sensors 101, 103 may be dedicated temperature sensors introduced specifically for the purposes of detecting temperature anomalies above the ceiling 102.

Either way, each sensor 101, 103 is arranged to be able to communicate with a user device 200 operated by a user 404 by any suitable wired or wireless communications method, which are in themselves known in the art. For example, each sensor may be provided with a wireless communications interface 409 enabling wireless communications such as WiFi, Bluetooth or ZigBee. By whatever means the communication is implemented, each sensor is thus able to communicate a respective signal indicative of its respective sensed temperature to a user device 200 (see below). Note also that this communication may be direct from each individual sensor 101, 103 to the user device 200, or via one or more intermediate nodes, such as a wireless router, or a centralized bridge or control module of the system (not shown).

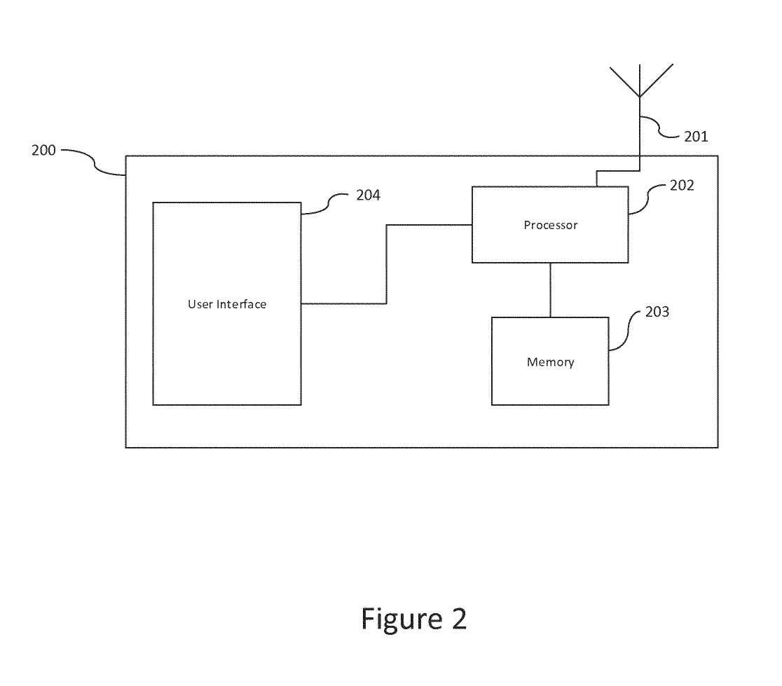

FIG. 2 provides a schematic block diagram of the user device 200. The user device 200 may be, for example, a mobile device such as a smartphone, tablet or laptop computer, or stationary device such as a desktop computer or a wall-mounted device (e.g. wall panel). The user device 200 may be a general purpose device like a smartphone, tablet or computer programmed to perform the disclosed detection, or may be a dedicated device such as a dedicated wall panel dedicated to the utility or detection system.

Referring to FIG. 2, the user device 200 may comprise a processor 202, a memory 203, a user interface 204, and communication interface 201. The processor 202 is operably coupled to the user interface 204, memory and communications interface. Hence, the processor is able to process the incoming signals received from the temperature sensors 101, 103 via the communications interface 201, perform read/write operations from/to memory, and output information via the user interface. The processor 202 is thereby configured to implement detection logic in accordance with any of the embodiments disclosed herein. In embodiments, the processor 202 may additionally be able to receive input from the user interface 204 and output signals to the communications interface 201. Note also that the detection logic may be implemented in hardware, software or any combination of hardware and software, but for the purpose of illustration the following will be described as being performed by a processor 202.

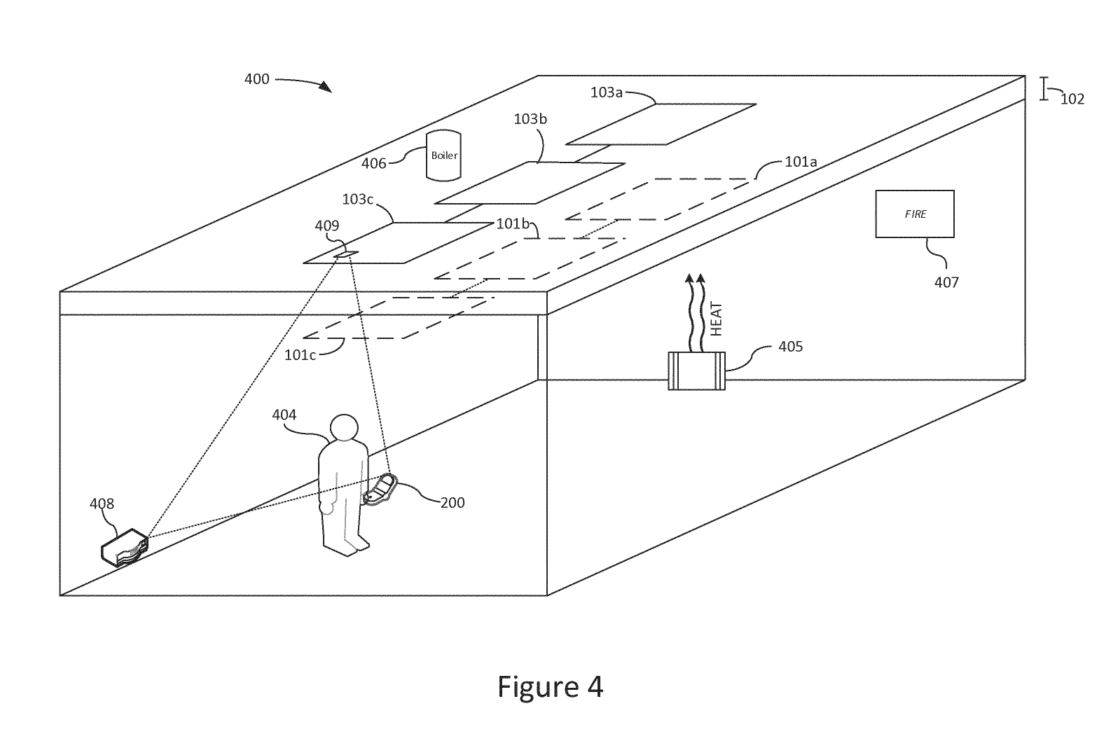

Suitable communications means to implement the interface 204 are in themselves known in the art and so only briefly discussed here. FIG. 2 shows a wireless antenna 201, but the relevant communications may be carried out using any wireless or wired communication which allows collection of sensor data. Accordingly, the communication need only be uni-directional. Bi-directional communications may be useful to allow the user device 200 to output control signals to control one or more aspects of the system (e.g. control the lighting, cancel an alert, or shut off a temperature control device such as a heater, boiler or air conditioning unit). Any of the disclosed communications may be either direct between each sensor 101, 103 and the user device 200 or via a third device such as a router 408 (see FIG. 4). It is also not excluded that the communications interface 204 is equipped to communicate according to multiple different types of communication technologies, i.e. not all of the sensor signals or other communications disclosed herein have to be communicated by the same means (e.g. some could be via ZigBee while others are via Wi-Fi, or some are wired while others ae wireless).

The user interface 204 may comprise a user interface integrated into the same unit (in the same housing) as the processor 202 and communications interface 201, e.g. into the same mobile terminal; and/or the user interface 204 may comprise an external user interface external to that unit or terminal, e.g. an external monitor or a wall- or ceiling mounted alarm. The user interface 204 may comprise a graphical user interface such as an LCD or LED screen. In this case, the graphical user interface can display information to the user and may also receive input commands from the user (e.g. via a touch screen or point-and-click interface). Alternatively, the user interface 204 may comprise an alarm 407 (see FIG. 4). Here, the user interface 204 comprises a speaker and/or a lighting device and the user interface can alert the user to information through the use of audio and/or visual outputs, e.g. “FIRE” as shown on alarm unit 407 in FIG. 4.

The processor is operably connected to the communication interface 201, the user interface 204, and optional memory 203. Accordingly, data signals from the sensors 101, 103 received by the communication interface 201 in a manner described above can be processed by the processor 202 to generate heat maps, and then the heat maps can be compared to generate an output to the user interface. The memory may store, among other things, temperature history data and/or threshold values (discussed later).

Note also that the user device 200 may be implemented in either a single unit, or alternatively in the form of a distributed computing system, wherein each of the user interface 204, processor 202 and memory 203 is located in a separate physical entity; and/or wherein the functionality of any given one of the user interface 204, processor 202 and/or memory 203 is implemented in more than one physical entity (with suitable communications interfaces such as those disclosed above included in each entity for implementing the communications between the different entities and between these entities and the sensors 101, 103) . For example, a mobile user device which could be used to communicate with the network of sensors 101, 103 but not itself display information, and rather the user device could output the relevant data to an external user interface 407 which would convey the information to the user. As a further example, the processor 202 may be implemented in a building management system, or one of the devices in a networked lighting system such as a controller or one of the luminaires. Also, the processor 202 could be distributed amongst multiple entities, as could the memory 203. In general, the heat maps do not need to be compared by the same entity which generates them. For example, the processor implemented in one of the luminaires could generate the heat maps and then forward them to another entity such as a user terminal or building management system to be compared.

However the system is implemented, the processor 202 is configured to use the output data from the sensors 101, 103 to generate a heat map mapping the temperature senses above and below the ceiling 102 at a plurality of different positions.

To do this, spatial information is required in addition to temperature information, which may be acquired through the use of multiple sensors 101, 103 at different known locations (known to the processor 202, being stored in the memory 203). For example this information could take the form of GPS coordinates of the sensors 101, 103 or their locations on a floor plan, as acquired by any method known in the art. E.g. the locations of the luminaires on an office floor plan, and thus also the locations of the temperature sensors inside the luminaires, may be acquired during a commissioning step.

Alternatively, an individual sensor capable of providing directional and/or spatial information, such as an IR camera, may be used to generate a heat map for a given side of the ceiling 102. In yet further alternatives, a spatial heat map is not absolutely necessary and an alert could be generated based on a comparison of only a single sensor reading above the ceiling 102 with only a single sensor below the ceiling. Nonetheless, the use of a map generated based on multiple sensors above the ceiling 102 and multiple below may be preferred in order to extract more information about potential anomalies, and the following will be described in terms of such preferred embodiments.

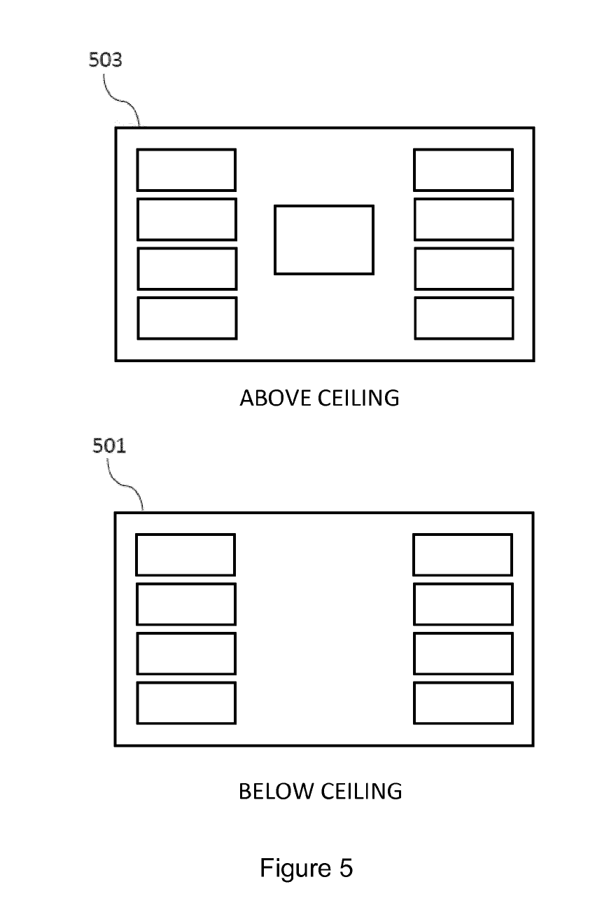

A heat map indicates the spatial distribution of heat over the array. FIG. 5 shows an example of an upper heat map 503 generated from the output data of an upper array of sensors 103 which shows the spatial distribution of heat above the ceiling 102, e.g. in an office this would relate to the area above the suspended ceiling where certain equipment, ducts, etc. are located. Similarly, a lower heat map 501 may be generated from the output data of lower array of sensors 101 which characterises the spatial distribution of heat below the ceiling 102, e.g. in an office this would be the room where office workers are located.

FIG. 4 illustrates an environment 400 such as an office space comprising a ceiling 102 in which the present invention may be employed. The term “ceiling” may refer to either the structural ceiling of a room or a dropped (suspended) ceiling as typically present in an office space. Three upper sensors 103a, 103b and 103c and three lower sensors 101a, 101b and 101c are shown, but embodiments may be carried out with any combination and number of upper and lower sensors.

For illustrative purposes the upper sensor 103c is shown as comprising a wireless communications interface 409 for transmitting its sensor reading to the user device 200, but it will be appreciated that the other upper and lower sensors 101, 103 also comprise such a communications interface (and that any of these interfaces could be wired or wireless). Thus each sensor 101, 103 is able to provide information to the processor 100 carrying out the methods as disclosed herein by, for example, each individual sensor 101, 103 being able to communicate directly with the user device 200. Alternatively, the sensors 101, 103 may be able to communicate with each other, and a single access point to this network may be provided to allow these “networked” sensors 101, 103 to communicate with the user device 200. FIG. 4 also shows a router 408 and example communication paths (dotted lines). The communications between the sensors 101, 103 and the user device 200 may be via the router, or direct. An external user interface 407 is illustrated as a wall-mounted screen, though this may be implemented with any suitable sensory alarm enabling the user to be alerted to potential hazards. As example heat sources and potential hazards, FIG. 4 shows a boiler 406 above the ceiling 102 and a radiator 405 below the ceiling.

As discussed above in relation to FIG. 1, the sensors 101, 103 are primarily disposed to detect heat sources on their own respective side of the ceiling. For example, heat generated by boiler 406 will be detected far more by the upper sensors 103 than the lower sensors 101 (if at all). Additionally, the heat from the boiler will dissipate with distance resulting in a higher temperature output from those sensors which are closest to the boiler (i.e. sensor 103b).

Also shown is a heat source below the ceiling 102 such as a radiator 405. Again, heat from the radiator will primarily be detected by lower sensor 101a as this sensor is below the ceiling 102 and closest to the radiator. However, it may also be detectable by sensor 103a due to the fact that heat rises.

As discussed above, the upper and lower heat maps should share at least some degree or spatial similarity. This allows effects measured above the ceiling 102 yet caused by heat dissipation occurring below the ceiling 102 to be filtered out. By comparing the upper and lower heat maps 503, 501, the processor 200 is able to determine and classify differences between them as described below.

The term “heat spot” as used herein is used to refer to any spatially localised variation in temperature. For example, heat map 503 shown in FIG. 5 displays nine heat spots (note that the central heat spot in the upper heat map 503 is not present in lower heat map 501). It is understood that the term heat spot applies equally to increases as well as decreases in temperature (or “cold spots”), e.g. a HVAC leaking cold air. Generally, the invention may be used to detect either type of “temperature spot”.

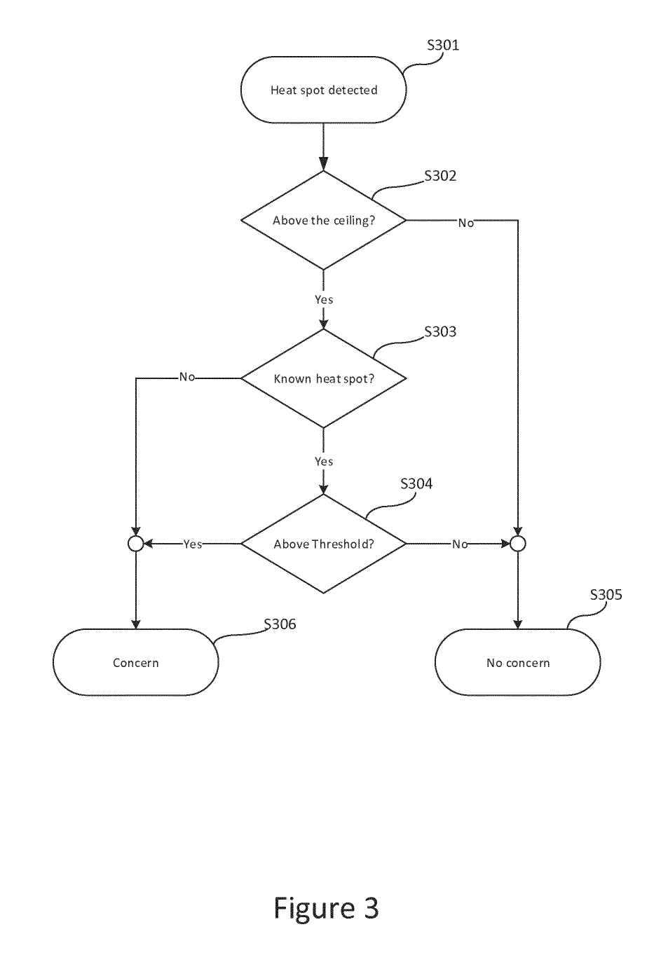

With reference to the flow diagram of FIG. 3, a method is provided for classifying the heat spots as “concern” and “no concern”. If it is determined that a detected heat spot is a concern, the user interface 204, 407 alerts the user as this heat spot may indicate a potential hazard. On the other hand, a heat spot which is no concern need not generate an alert.

When a heat spot is detected S301, the location of the heat spot can be determined S302 as discussed above by the location of the sensor with the most significant output. Heat spots below the ceiling 102 may or may not cause concern. However, traditional fire alarm systems based on simple heat detection are known and widely used. Therefore, for the purposes of the present invention, if the heat spot is below the ceiling (i.e. it was detected primarily by a lower sensor) then the method proceeds to step S305 and the heat spot is classified as “no concern” and are left to the traditional fire alarm system.

For heat spots above the ceiling, the method proceeds, in step S303, to determine if it is a known heat spot occurring due to a known heat source. An unknown heat source above the ceiling 102 should result in a concern S306 and hence the user should be notified. Devices above the ceiling may generate known heat spots but, for example, wiring may not normally generate heat. A crack in the wiring might result in the sudden appearance of an unknown heat spot which cannot be attributed to any known device. Accordingly, this heat spot is a concern.

If the heat spot is a known heat spot, the method proceeds to step S304. Here, the heat spot is compared to a threshold value which may define an acceptable operating temperature range of the known heat source. If the heat spot is within this range, e.g. below the threshold, then this heat spot can be classified as no concern S305. Similarly, if the heat spot it outside this range, e.g. above the threshold, then it can be classified as a concern S306. Note that the alert or notification generated by this concern (a known heat spot exceeding the acceptable range) may differ from the alert or notification generated by an unknown heat spot (as earlier described).

More generally, step 304 may consist of classifying the heat spots with reference to one or more criteria, e.g. by considering a general criterion which defines whether a known heat spot is or is not a concern. A criterion in this context may be a temperature range, spatial range, temporal range, or any combination thereof. An identified temperature anomaly can then be compared to at least one criterion as described below by way of examples.

A temperature range, or temperature criterion, may be a predetermined absolute temperature value or values (e.g. in degrees Celsius, Fahrenheit, Kelvin). A single value may be sufficient to define an acceptable temperature range. For example, a known heat spot above a given threshold (or equivalently a known cold spot below a given threshold) causes a concern. Alternatively, upper and lower bounds may be defined such that any temperature anomaly falling outside this range causes a concern.

A spatial range, or spatial criterion, may be a predetermined size and/or location. For example, in normal operating conditions a boiler may create a circular known heat spot one metre across. If this heat spot grows to five metres across, it should cause a concern. Additionally, a spatial criterion may define certain locations in a building, allowing areas of higher risk to trigger concern more easily. For example, the area immediately surrounding a store room containing explosives should err on the side of caution when classifying heat spots.

A temporal range, or temporal criterion, may be a predetermined absolute time or times and/or duration. Here, “absolute time” is understood to mean any specific time of the day, week, and/or month, etc. For example, a temperature anomaly occurring outside of office hours may cause a concern. Duration criteria may be used, for example, to prevent “spikes” from causing concern. That is, a heat spot which would otherwise have caused a concern could be deemed not a concern if it is sufficiently short-lived. Another option is to specify a duration for which a heat spot must persist before a concern is triggered.

In accordance with the method described above, the present invention allows concerning heat spots to be identified in an environment, even when out of view (e.g. above a ceiling 102). In addition to a general alert to the user, the processor 200 may be configured to provide the user with other information such as the severity of the concern of the approximate location of the heat spot, thus allowing the user to address the cause more directly.

Alternatively or additionally, the processor 200 may be configured to carry out some steps to diagnose the cause, or at least determine with greater accuracy that there is an issue. This may be achieved by considering spatial information, temporal information, thermal information and/or any combination thereof.

For example, via the communications interface 201 (using the same or a different communication technology as that used to receive the sensor signals), the processor 200 may also be configured to be able to control one or more temperature control devices that may be a potential cause of the anomaly, e.g. one or more heaters 405, boilers 406, air conditioning units, and/or electrical devices that could generate heat when faulty. To try to diagnose the source, the processor 200 may be configured to systematically turn off individual ones of these potential sources of the anomaly, and to observe the effect of this on the heat maps 501, 503. If after turning off a specific device the heat spot is no longer visible in the heat map, yet it returns when the same device is turned on again, this can be an indication that this device is faulty (especially if there are multiple other similar devices that do not cause the same issue). The processor may then provide the user with more specific information relating to the problem via the user interface 204.

Alternatively or additionally, the processor 200 may also be provided with location information for one or more potential sources of the anomaly (e.g. stored in the memory 203). In this case, this information can be used to aid diagnosis. For example, it may be assumed that a localised temperature anomaly is caused by a device in known to be located in the same area. As another example, the temperature information itself may aid diagnosis. For example, if the temperature anomaly is a hot spot of one hundred degrees Celsius (or within some window around this) then it may be assumed that a boiler 406 is the cause (as one hundred degrees Celsius is the temperature of boiling water). As yet another example, temporal information may aid diagnosis. Examples include the time which a device was turned on, the active time of a device, the time of day, even past behaviour characterising the failure rate of certain devices. For example, if a certain HVAC unit is defective and fails frequently, it may be advantageous to assume this is the cause of a temperature anomaly, especially when combined with spatial/thermal information as described above.

In yet further alternative or additional embodiments, the processor may again be able to control various devices in the system, but rather than diagnosis this may be used to mitigate the effect of a detected temperature anomaly. This may be achieved via the communications interface 201, using the same or alternative wired or wireless communication means as used to collect the sensor signals. The devices being controlled may be the networked devices themselves (i.e. the boilers/heaters/HVAC etc.) or further devices present in the environment (such as fire suppression means, e.g. sprinklers). In these embodiments, the processor 200 may carry out some further steps to attempt to mitigate or control the issue. Appropriate action may be determined by pre-set actions stored in the memory 203 or “on the fly” by the processor 202. For example, the memory may store information instructing the sprinklers to be turned on for a temperature anomaly exceeding a certain threshold level such as five hundred degrees centigrade (as this may indicate a fire). Alternatively, more general rules such as “turn off the device causing the anomaly” may be employed, e.g. the one or more devices emitting heat could be turned off. A further alternative is to actively counteract the temperature anomaly, e.g. the HVAC system could be controlled to heat up/cool down an area to counteract the heat spot.

It will be appreciated that the above embodiments have been described only by way of example. Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor or other unit may fulfil the functions of several items recited in the claims. The mere fact that certain measures are recited in mutually different dependent claims does not indicate that a combination of these measured cannot be used to advantage. A computer program may be stored and/or distributed on a suitable medium, such as an optical storage medium or a solid-state medium supplied together with or as part of other hardware, but may also be distributed in other forms, such as via the Internet or other wired or wireless telecommunication systems. Any reference signs in the claims should not be construed as limiting the scope.

1. A device comprising:
a communications interface configured to receive one or more first signals each indicating a respective temperature level sensed by a respective first temperature sensor located above a ceiling, and to receive one or more second signals each indicating a respective temperature level sensed by a respective second temperature sensor located below said ceiling; and
detection logic configured to;
generate a first heat map based on the one or more first signals;
generate a second heat map based on the one or more second signals; and
compare the first heat map with the second heat map to identify a temperature anomaly above or below said ceiling, and thereby generate an output indicative of said temperature anomaly.

2. (canceled)

3. The device of claim 1, wherein the detection logic is further configured to identify a location of the temperature anomaly based on said comparison, and the output is indicative of the location of the temperature anomaly.

4. The device of claim 1, wherein the detection logic is further configured to determine a cause of the temperature anomaly based on
said comparison, and the output is further indicative of said cause of the temperature anomaly.

5. The device of claim 4, wherein the detection logic is further configured to control one or more temperature control devices based on the cause of the temperature anomaly to mitigate said cause of the temperature anomaly.
6. The device of claim 1, wherein:
the device further comprises a memory storing at least one predetermined criterion defining the temperature anomaly in terms of at least one respective difference to be detected based on the comparison of the one or more first signals and the one or more second signals; and
the processor is further configured to perform said comparison by reference to the at least one criterion.
7. The device of claim 1, wherein the temperature anomaly is a hot spot.
8. The device of claim 1, wherein the temperature anomaly is a cold spot.
9. The device of claim 1, wherein the first and second temperature sensors are each one of a passive infrared sensor, a driver in a luminaire, a power sourcing equipment, a climate system, a thermopile, a pyrometer, a thermistor, a thermocouple, a thermopile, and a bi-metallic strip.

10. A system for detecting potential hazards in a network of temperature sensors comprising:
a device comprising a communications interface and detection logic;
a first temperature sensor located above a ceiling;
a second temperature sensor located below said ceiling; and wherein:
the communications interface is configured to receive one or more first signals indicating a temperature level sensed by the first temperature sensor, and to receive one or more second signals indicating a temperature level sensed by the second temperature sensor; and
the detection logic is configured to: generate a first heat map based on the one or more first signals; generate a second heat map based on the one or more second signals; and compare the first heat map with the second heat map to identify a temperature anomaly above or below said ceiling, and thereby generate an output indicative of said temperature anomaly.

11. The device of claim 10, wherein said surface ceiling is a horizontal ceiling.

12. (canceled)

13. The device of claim 1, wherein said one or more first signals are a plurality of first signals each indicating a respective temperature level sensed by a respective one of a plurality of first heat sensors, and said one or more second signals are a plurality of second signals each indicating a respective temperature level sensed by a respective one of a plurality of second heat sensors.

14. A method comprising steps of:
receiving one or more first signals indicating a temperature level sensed by a first heat sensor located above a ceiling,
receiving one or more second signals indicating a temperature level sensed by a second heat sensor located below said ceiling.
generating a first heat map based on the one or more first signals,
generating a second heat map based on the one or more second signals,
comparing the first heat map with the second heat map to identify a temperature anomaly above or below said ceiling, and
generating an output indicative of said temperature anomaly.

15. A computer program product embodied on a non-transitory computer-readable storage medium which when run on one or more processors carries out the method of claim 14.
